(19) United States
(12) Patent Application Publication
(10) Pub. No.: US 2014/0345321 A1
(43) Pub. Date: Nov. 27, 2014

(54) Biocompatible Sintered Diamond Jewelry

(71) Applicants: David R. Hall, Provo, UT (US); Ronald B. Crockett, Payson, UT (US); Neil Cannon, Provo, UT (US)

(72) Inventors: David R. Hall, Provo, UT (US); Ronald B. Crockett, Payson, UT (US); Neil Cannon, Provo, UT (US)

(21) Appl. No.: 13/900,735

(22) Filed: May 23, 2013

(51) Int. Cl. C04B 35/52; C04B 41/53; C04B 35/645; A44C 17/00; A44B 5/00

(52) U.S. Cl. CPC C04B 35/52; A44C 17/00; A44B 5/00; C04B 35/645; C04B 41/53
USPC 63/4; 63/32; 63/15; 63/38; 63/3; 63/12; 24/41.1; 264/603

(57) ABSTRACT

An article of jewelry for wearing on the body may comprise a sintered polycrystalline diamond compact with substantially no metal catalyst. As many of the metal catalysts commonly used in the art are known to cause skin irritation, such a sintered compact with substantially no metal catalyst may be more biocompatible than previously known. A method for forming such a biocompatible sintered polycrystalline diamond compact comprises mixing diamond powder and metal catalyst powder into a mixture and sintering the mixture under elevated temperature and pressure conditions to form a sintered compact. The sintered compact may then be leached in an acid or other solution to substantially remove the metal catalyst from the sintered compact.

### CROSS REFERENCE TO RELATED APPLICATIONS

This application claims priority to U.S. Provisional Pat. App. No. 61/651,592, which is incorporated herein by reference for all that it contains.

### BACKGROUND OF THE INVENTION

The present invention relates to jewelry comprising sintered polycrystalline diamond and especially sintered polycrystalline diamond that is biocompatible with human skin.

Jewelry may be manufactured from a variety of materials. The properties of certain materials have made them more popular for jewelry manufacture than others. For example, metals and metal alloys (e.g., gold, silver and platinum) that are resistant to corrosion, malleable and lustrous have been found particularly desirable for jewelry manufacture. Additionally, gemstones (e.g., diamond, rudy, sapphire and emerald) and certain types of ceramics (e.g., cemented tungsten carbide) that are hard, polishable and shiny are also popular.

Sintered polycrystalline diamond is an ultrahard material commonly used for industrial purposes due to its toughness and abrasion resistance. Polycrystalline diamond is often manufactured by sintering diamond powder with a metal catalyst powder in a high-pressure, high-temperature environment. The metal catalyst aids intercrystalline diamond bonding while sintering. Common metal catalysts used in the industry include cobalt and nickel.

Some have attempted to manufacture jewelry using sintered polycrystalline diamond due to its unique properties and appearance. However, many of the metal catalysts commonly used are known to cause skin irritation as well as other biocompatibility problems.

For example, U.S. Pat. Pub. No. 2011/0146348 to Harding et al., which is herein incorporated by reference for all that it contains, describes how sintering polycrystalline diamond in the presence of cobalt and/or nickel has been a barrier to its use as a bulk jewelry material as those elements are both known to cause skin allergies. Harding recommends sintering diamond with a specific catalyst recipe including about 33 to 50 percent Sn, about 38 to 45 percent Co, about 10 to 19 percent Cr, and up to about 4 percent Mo to create a biocompatible part.

U.S. Pat. Pub. No. 2007/0082229 to Mirchandani et al., which is herein incorporated by reference for all that it contains, also acknowledges the toxic effects of cobalt and nickel calling them “known carcinogens” and asserting that they are widely known to cause allergies and skin rashes. To allow certain cemented carbides to be used for jewelry, Mirchandani discloses leaching or otherwise removing cobalt and/or nickel from exposed surfaces thereof to create a binder-depleted zone. However, Mirchandani warns to deplete the binder only at and near the surface, such that the bulk properties of the cemented carbide are not compromised or altered in any manner.

Therefore, despite past efforts to use sintered polycrystalline diamond in jewelry, the existence of toxic catalyst materials therein has hindered its widespread adoption. Thus, there exists a need for a sintered polycrystalline diamond which may remain in contact with the human body without irritation or harmful effects.

### BRIEF SUMMARY OF THE INVENTION

It is an object of the present invention to provide an improved sintered polycrystalline diamond compact for use in jewelry. It is a further object to provide a method for producing such a sintered polycrystalline diamond compact.

To this end, an article of jewelry for wearing on the body is disclosed comprising a biocompatible sintered polycrystalline diamond compact with substantially no metal catalyst. The article of jewelry may be a ring, pendant, cuff link, bead, bracelet, bangle, chain, necklace, earring, watch, watch case, watch strap or any other type of jewelry known in the art. The sintered polycrystalline diamond compact may form the article of jewelry on its own or may be mounted on a different material.

In one embodiment of the present invention as described, a ring may be formed from two hollow cylindrical bodies. An internal hollow cylindrical body may be formed of a material such as gold and an external hollow cylindrical body may surround the gold and be formed of sintered polycrystalline diamond compact. In further embodiments, the external hollow cylindrical body may comprise at least one slit therein such that the ring may be resized without cracking the generally brittle sintered polycrystalline diamond compact. Gemstones, initials, crests or other features common to jewelry may be inserted within the slit to further enhance the aesthetic value of the ring.

In other embodiments of the present invention, a compact mass of sintered polycrystalline diamond compact may be mounted in a manner known in the art on a ring, pendant, cuff link, bracelet, bangle, earring, or watch formed of a material such as gold.

The article of jewelry may comprise a biocompatible filler material disposed on its surface.

A method for forming a biocompatible sintered polycrystalline diamond with substantially no metal catalyst as described previously comprises first mixing diamond powder and metal catalyst powder into a mixture. The mixture is then sintered under elevated temperature and pressure conditions to form a sintered compact. Finally, the metal catalyst is substantially removed from the sintered compact by placing the sintered compact in a solution that acts to leach the metal catalyst from the sintered compact.

In assorted embodiments of the present invention, the solution used to leach the metal catalyst from the sintered compact may be a solution consisting of an acid such as HF, HCl, HBr, HI, H₂SO₄, HNO₃, HClO₃, HClO₄ or combinations thereof. Additionally, a basic solution may be used to neutralize the acid. In other assorted embodiments of the present invention, the solution may consist of ferric chloride, sodium persulfate, sodium tetrafluoroborate, sodium citrate, sodium pyrophosphate, boric acid, or combinations thereof.

Other additional steps may be taken in various embodiments of the present invention such as sealing the mixture in a canister before sintering and/or filling voids in the sintered compact left from the substantial removal of metal catalyst with a biocompatible filler material. When sealed in a canister, a cylinder may be disposed within the canister surrounded by mixture to form a ring shape. The cylinder may be removed after sintering by thermal contraction or dissolution. A ring of a different material such as gold may be fit within the sintered compact ring. Such an internal ring may be replaced with one of a different internal geometry for resizing.

### BRIEF DESCRIPTION OF THE DRAWINGS

FIGS. 1a and 1b show magnified cross-sectional views of embodiments of sintered polycrystalline diamond compacts with and substantially without metal catalyst respectively.

FIG. 2 shows a perspective view of an embodiment of a ring formed of sintered polycrystalline diamond compact.

FIG. 3 shows a perspective view of an embodiment of a ring formed of sintered polycrystalline diamond compact and a different material.

FIG. 4 shows a perspective view of another embodiment of a ring formed of sintered polycrystalline diamond compact and a different material, wherein the sintered polycrystalline diamond compact comprises a slit there through.

FIG. 5 shows a perspective view of an embodiment of a necklace comprising a pendant hanging from a chain.

FIG. 6 shows a perspective view of an embodiment of a pair of cuff links.

FIG. 7 shows a perspective view of an embodiment of a wrist watch.

FIG. 8 shows a perspective view of an embodiment of a bracelet formed of sintered polycrystalline diamond compact mounted on a band of a different material.

FIG. 9 shows a perspective view of an embodiment of a necklace comprising a plurality of sintered polycrystalline diamond compact beads.

FIG. 10 shows a perspective view of an embodiment of a pair of earrings.

FIG. 11 shows a flow diagram of a method for forming a biocompatible sintered polycrystalline diamond compact.

### DETAILED DESCRIPTION OF DRAWINGS

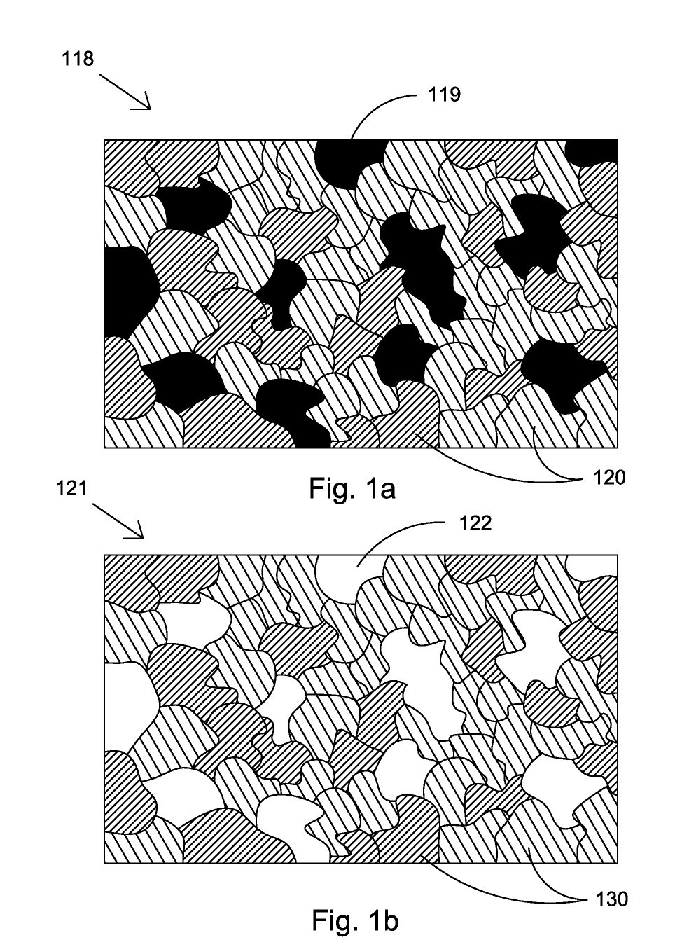

Referring now to the figures, FIG. 1a discloses one possible embodiment of the grain structure of a sintered polycrystalline diamond compact. To form such a sintered compact, diamond powder may be mixed with metal catalyst powder, such as cobalt or nickel, to form a powder mixture. The powder mixture may be formed into various shapes and sizes utilizing a variety of canisters, molds, dies, cores, or other objects to sculpt the powder mixture into a near-net shape. For example, the powder mixture may be disposed and temporarily retained within a canister comprising a desirable external geometry. The canister may then be exposed to a high-pressure, high-temperature environment, such as produced in HPHT presses known in the art, which may cause crystalline growth to occur between grains of diamond powder. The crystalline growth may be aided by the presence of the metal catalyst powder.

Various types of metal catalyst powder may be mixed with diamond powder to produce a sintered compact. Different metal catalysts will produce sintered compacts with different properties such as varying degrees of hardness. Thus, the freedom to use a variety of metal catalysts or combinations thereof allows for greater customization of the finished properties of the sintered compact.

As shown in FIG. 1a, a sintered compact 118 may comprise diamond grains 120 comprising crystalline structures in an assortment of orientations. During sintering, some of the diamond grains 120 comprising similar crystalline structure orientations may bond together. Pockets of metal catalyst 119, remnants from the sintering process, may be interspersed among the diamond grains 120. As many metal catalysts, such as cobalt and nickel, are known to cause irritation to skin along with other biocompatibility problems, it may be desirable to remove the metal catalyst 119 from the sintered compact; especially if the sintered compact is intended to be used for jewelry manufacture.

FIG. 1b discloses an embodiment of the grain structure of a sintered polycrystalline diamond compact wherein metal catalyst has been substantially removed. A sintered compact 121 is shown comprising diamond grains 130 forming a plurality of crystalline structures. Voids 122 are interspersed among the diamond grains 130 where metal catalyst previously existed. Metal catalyst may have been substantially removed from the sintered compact 121 by submerging the sintered compact 121 in a solution, which may act to leach the metal catalyst from the sintered compact while leaving the polycrystalline diamond intact. The substantial removal of metal catalyst may aid in creating a more biocompatible article.

According to one embodiment of a leaching process, a sintered compact is placed within an acid solution such that the sintered compact is submerged within the acid solution. The acid solution may be selected from a group of acids such as HF, HCl, HBr, HI, H₂SO₄, HNO₃, HClO₃, HClO₄ or combinations thereof. In other embodiments, the solution may comprise ferric chloride, sodium persulfate, sodium tetrafluoroborate, sodium citrate, sodium pyrophosphate, boric acid, or combinations thereof. The solution may react with the metal catalyst to substantially remove it from the sintered compact. It is said that the metal catalyst is “substantially” removed because trace amounts may remain in the leached sintered compact that are completely surrounded by diamond crystals, thus preventing the solution from reaching and reacting with the metal catalyst. However, because these trace amounts of metal catalyst are surrounded by diamond crystals, their presence should not affect the biocompatibility of the sintered compact.

In some instances, when acidic solutions are used, it may be desirable to neutralize the acid to increase biocompatibility before the leached sintered compact is brought into contact with skin. Neutralizing the acid may be accomplished by submerging the leached sintered compact in a basic solution which reacts with the acid retained within the sintered compact. The basic solution may be mildly basic, for example, having a pH of 8 to 11.

In some embodiments, voids left vacant by the substantial removal of metal catalyst from a sintered compact may be filled with a biocompatible filler material. Metals such as gold, silver or platinum may act as a suitable biocompatible filler material while providing aesthetic value. If the sintered compact is polished, such metal biocompatible filler materials may provide a reflective mirror-like finish. Alternatively, depending on the relative size of the voids, a metal biocompatible filler material may provide a sparkly starry-like finish.

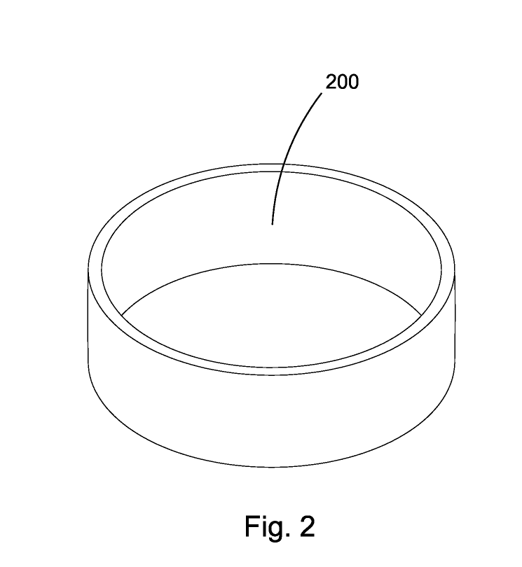

Various embodiments of jewelry incorporating biocompatible sintered polycrystalline diamond compacts will now be described. FIG. 2 discloses an embodiment of a ring 200 formed of sintered compact. Such a ring may be formed by disposing a metal cylinder in a canister surrounded by diamond powder and metal catalyst powder. As the canister is introduced into a high-pressure, high-temperature environment, the metal cylinder may expand while the powder mixture sinters. As the temperature is allowed to cool, the metal cylinder may contract, thus freeing itself from the now sintered hollow compact. In this manner, a single ring may be formed or a longer hollow compact may be formed which may then be cut into a plurality of rings by electrical discharge machining, laser cutter, or some other method known in the art. Another method of forming a ring as described comprises disposing a salt based cylinder or another dissolvable material in a canister surrounded by the powder mixture. After sintering, the cylinder may then be dissolved to expose the sintered hollow compact.

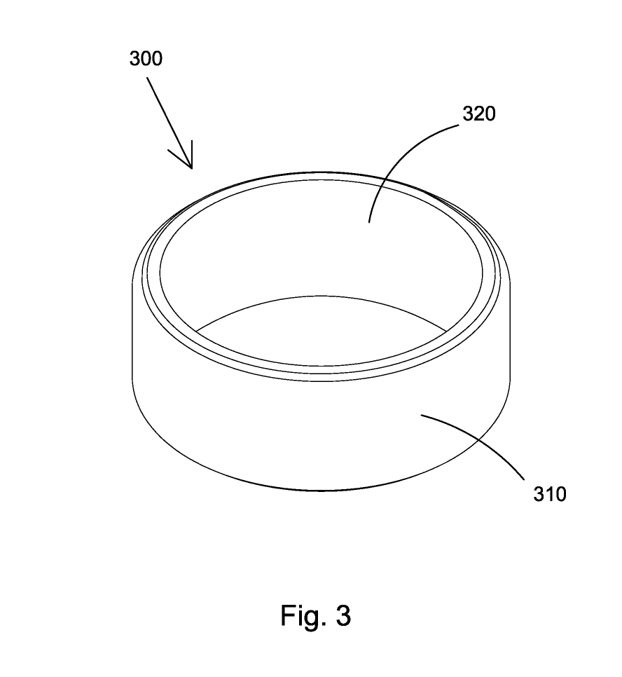

FIG. 3 discloses another embodiment of a ring 300. The ring 300 comprises an outer hollow cylindrical body 310 formed of sintered compact and an inner hollow cylindrical body formed of a different material 320. The different material 320 may be any material used in jewelry manufacture as known in the art, however, it is contemplated that a metal such as gold, silver, or platinum may be desirable for aesthetic as well as fabrication considerations. Such a metal as herein described may be inserted and fit inside the sintered compact by thermally contracting the metal and then allowing it to expand. This method of fitting the inner hollow cylindrical body within the outer hollow cylindrical body may be used to resize the ring by interchanging the inner hollow cylindrical body with others of varying sizes as desired.

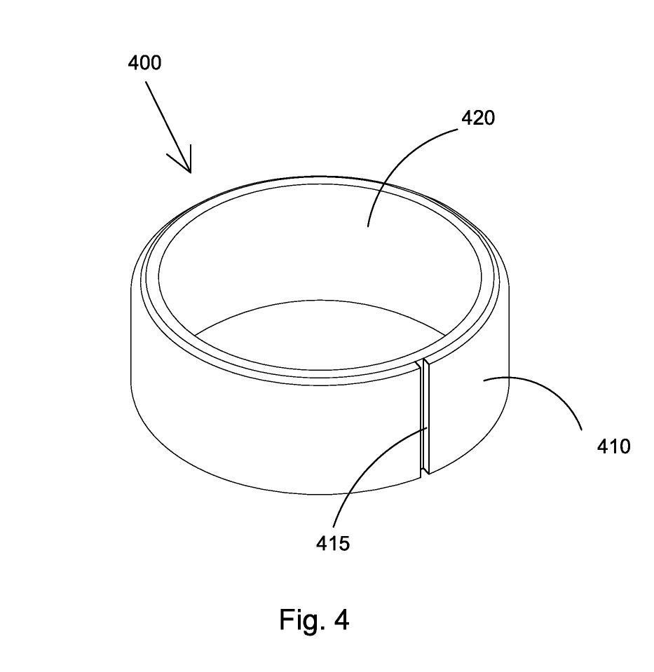

FIG. 4 discloses another embodiment of a ring 400 capable of resizing. The ring 400 comprises an outer hollow cylindrical body 410 formed of sintered compact and an inner hollow cylindrical body formed of a different material 420. The outer hollow cylindrical body 410 may contain a slit 415 therein. The different material 420 may comprise a metal such as gold, silver, or platinum such that it may be resized. The slit 415 may allow the outer hollow cylindrical body 410 to flex without breaking as the different material 420 is resized. Gemstones, initials, crests or other features common to jewelry may be inserted within the slit to further enhance the aesthetic value of the ring.

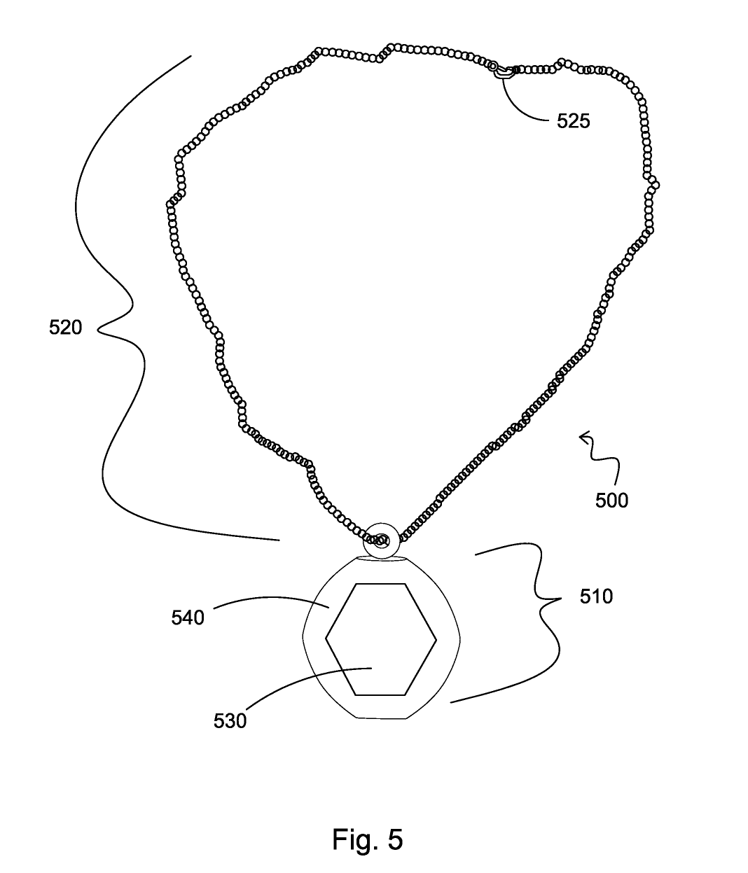

FIG. 5 discloses an embodiment of a necklace 500 comprising a pendant 510 hanging from a chain 520. The pendant 510 may comprise a mass of biocompatible sintered polycrystalline diamond compact 530 mounted on a mass formed of a different material 540 such as gold, silver or platinum. The chain 520 may be held together by a clasp 525.

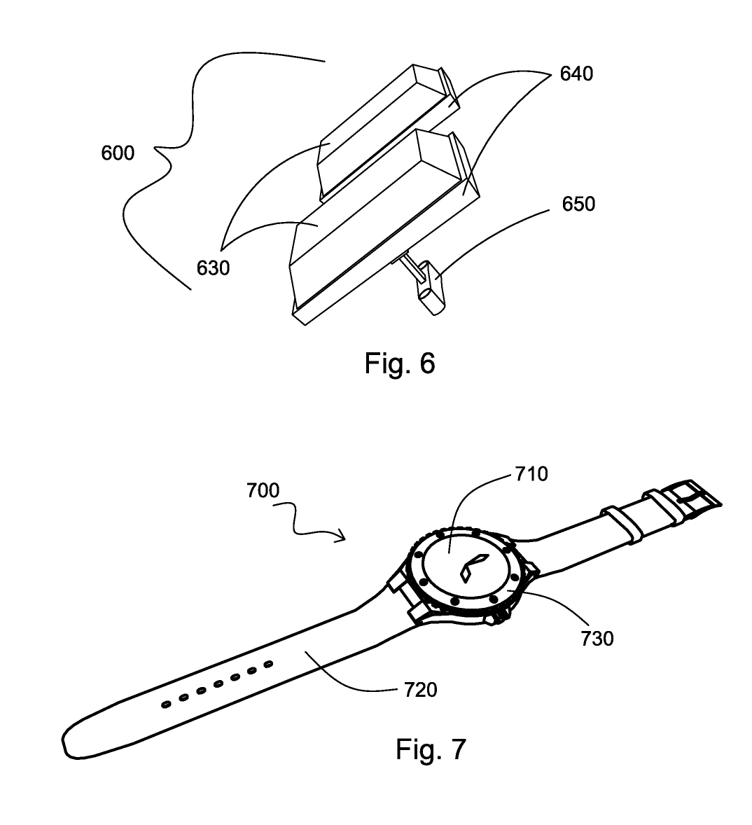

FIG. 6 discloses an embodiment of a pair of cuff links 600. Each of the cuff links 600 may comprise a mass of biocompatible sintered polycrystalline diamond compact 630 mounted on a mass formed of a different material 640 such as gold, silver or platinum. The mass formed of a different material 640 may comprise a stem 650 extending there from formed to fit within a button hole of a shirt sleeve.

FIG. 7 discloses an embodiment of a wrist watch 700. The wrist watch 700 may comprise a face 710 on which the time can be read and a band 720 (as shown), strap or bracelet to secure the wrist watch 700 around a wearer's wrist. In the embodiment shown, a bezel 730 of the watch is formed from biocompatible sintered polycrystalline diamond compact. It is contemplated that other embodiments may comprise other types of watches, such as pocket watches, as well as other uses of biocompatible sintered polycrystalline diamond compact such as for a watch's case or bracelet.

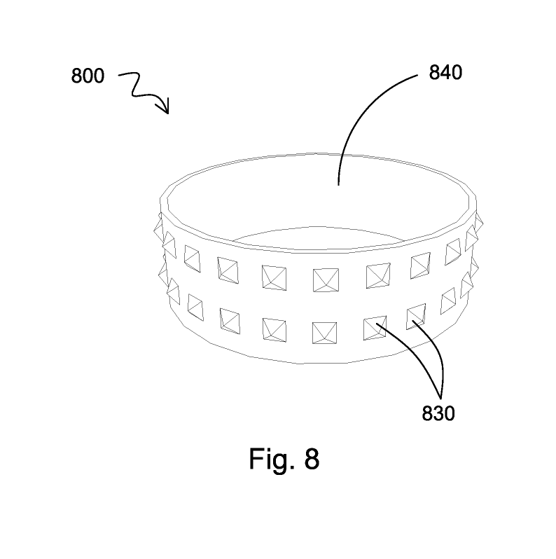

FIG. 8 discloses an embodiment of a bracelet 800. The bracelet 800 comprises a plurality of masses of biocompatible sintered polycrystalline diamond compact 830 mounted on a hollow cylindrical mass formed of a different material 840 such as gold, silver or platinum. The plurality of masses of biocompatible sintered polycrystalline diamond compact 830 may be mounted by any means commonly known in the art of jewelry manufacture and the bracelet is 800 is sized as to fit around a wearer's wrist.

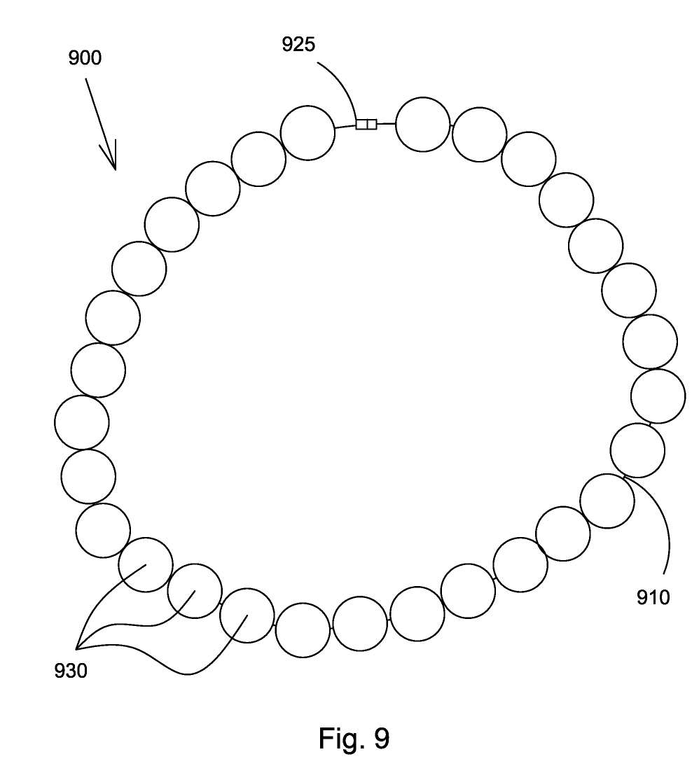

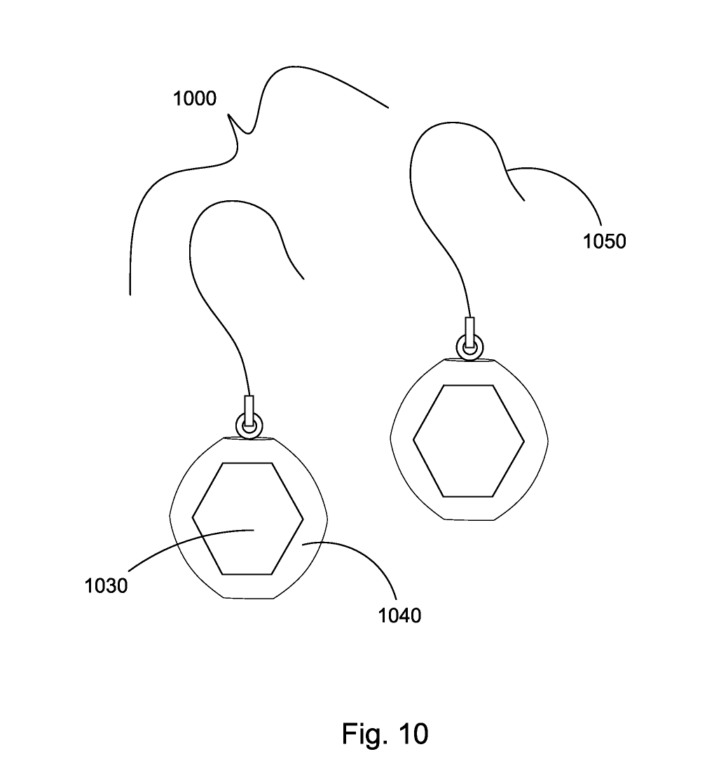

FIG. 9 discloses an embodiment of a necklace 900 comprising a plurality of biocompatible sintered polycrystalline diamond compact beads 930. The biocompatible sintered polycrystalline diamond compact beads 930 may comprise holes there through formed by electrical discharge machining, laser cutter, or some other method known in the art and be strung on a string 910 (as shown), wire or other type of cord known in the art of jewelry manufacture. The string 910 may be connected by a clasp 925, allowing the necklace 900 to be opened and closed.

FIG. 10 discloses an embodiment of a pair of earrings 1000. Each of the earrings 1000 may comprise a mass of biocompatible sintered polycrystalline diamond compact 1030 mounted on a mass formed of a different material 1040 such as gold, silver or platinum. Each of the earrings may comprise a wire 1050 extending there from formed to fit within a hole in an ear. Other embodiments may comprise studs or other methods known in the art to attach earrings to a wearer's ear.

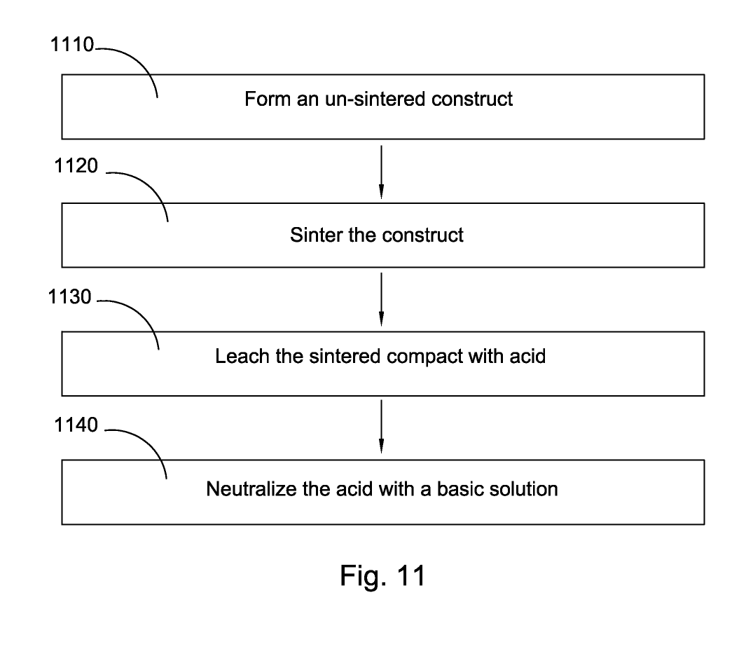

FIG. 11 discloses a flowchart of a method for forming a biocompatible sintered polycrystalline diamond compact. The method comprises first forming an un-sintered construct 1110 comprising a mixture of diamond powder and metal catalyst powder; next, sintering the construct 1120 under elevated temperature and pressure to thereby cause the diamond powder and metal catalyst powder to form a uniform sintered compact; and finally, leaching the sintered compact in an acid 1130 to thereby cause the substantial removal of the metal catalyst. In some embodiments of the present invention these steps are sufficient. In other embodiments, another step of neutralizing the acid with a basic solution 1140 is additionally performed. After neutralizing the acid, a filler material may be used to fill in the voids left from the leaching of the sintered compact. Additionally, further finishing processes may be performed such as grinding, electroplating, coating, polishing, or engraving personalized information.

Whereas the present invention has been described in particular relation to the drawings attached hereto, it should be understood that other and further modifications apart from those shown or suggested herein, may be made within the scope and spirit of the present invention.

What is claimed is:

1. An article of jewelry for wearing on the body, comprising:
a biocompatible sintered polycrystalline diamond compact with substantially no metal catalyst.

2. The article of jewelry of claim 1, shaped as a ring, pendant, cuff link, bead, bracelet, bangle, chain, necklace, earring, watch, watch case, or watch strap.

3. The article of jewelry of claim 1, further comprising a different material disposed adjacent the sintered compact.

4. The article of jewelry of claim 3, shaped as a ring and comprising a first hollow cylindrical body formed of the sintered compact and a second hollow cylindrical body disposed therein formed of the different material.

5. The article of jewelry of claim 4, wherein the first hollow cylindrical body comprises at least one slit such that the second hollow cylindrical body is resizable.

6. The article of jewelry of claim 5, wherein a gemstone or carving is disposed on the second hollow cylindrical body within the at least one slit.

7. The article of jewelry of claim 3, further comprising a compact mass formed of the sintered compact disposed on a ring, pendant, cuff link, bracelet, bangle, earring, or watch formed of the different material.

8. The article of jewelry of claim 1, wherein the sintered compact comprises a biocompatible filler material disposed on its surface.

9. A method for forming a biocompatible sintered polycrystalline diamond compact comprising:
mixing diamond powder and metal catalyst powder into a mixture;
sintering the mixture under elevated temperature and pressure conditions to form a sintered compact; and
leaching the sintered compact in a solution to substantially remove the metal catalyst from the sintered compact.

10. The method of claim 9, wherein the solution comprises an acid.

11. The method of claim 10, wherein the acid is selected from the group consisting of solutions of HF, HCl, HBr, HI, H₂SO₄, HNO₃, HClO₃, HClO₄, and combinations thereof

12. The method of claim 10, further comprising neutralizing the acid in the sintered compact by applying a basic solution.

13. The method of claim 9, wherein the solution is selected from the group consisting of solutions of ferric chloride, sodium persulfate, sodium tetrafluoroborate, sodium citrate, sodium pyrophosphate, boric acid, and combinations thereof.

14. The method of claim 9, further comprising sealing the mixture in a canister before sintering.

15. The method of claim 14, further comprising forming a first hollow cylindrical body of sintered compact by disposing a cylinder within the canister surrounded by the diamond powder and metal catalyst powder.

16. The method of claim 15, further comprising removing the cylinder after sintering by thermally contracting the cylinder.

17. The method of claim 15, further comprising removing the cylinder after sintering by dissolving the cylinder.

18. The method of claim 15, further comprising disposing a second hollow cylindrical body of a different material within the first hollow cylindrical body of sintered compact.

19. The method of claim 18, further comprising replacing the second hollow cylindrical body with a third hollow cylindrical body comprising a different internal geometry.

20. The method of claim 9, further comprising filling voids in the sintered compact left from the substantial removal of metal catalyst with a biocompatible filler material.
